(19) United States
(12) Patent Application Publication
(10) Pub. No.: US 2005/0087949 A1
(43) Pub. Date: Apr. 28, 2005

(54) Mud resistant motorcycle fender and liner assembly and method of using liner as a protective surface

(76) Inventor: Anthony J. Presby, Bedford Heights, OH (US)

Correspondence Address: LITMAN LAW OFFICES, LTD., P.O. BOX 15035 CRYSTAL CITY STATION, ARLINGTON, VA, 22215, US

(21) Appl. No.: 10/691,525

(22) Filed: Oct. 24, 2003

(51) Int. Cl. B62D 25/16; B62D 25/18

(52) U.S. Cl. 280/152.1; 280/152.3

(57) ABSTRACT

The mud resistant motorcycle fender and liner assembly incorporates a liner formed of a synthetic air permeable material adhesively mounted to the underside of an exposed motorcycle fender or to a structure having surfaces susceptible to mud buildup. The liner is a relatively thin, flexible sheet of air permeable, synthetic material formed to substantially cover the concave portion of an exposed fender. The liner has a bead of adhesive material disposed around the edge thereof, further securing the liner to the surface of the fender and protecting the edge from fraying and the lining from delaminating. A liner backing, sandwiched between the protective liner and the surface to be protected functions to prevent the protective liner from delaminating.

### BACKGROUND OF THE INVENTION

1. Field of the Invention

The present invention relates to mud protection devices, and more specifically, devices that prevent the buildup of mud under the fenders of motorcycles, multi-wheeled vehicles and exterior surfaces prone to collect mud.

2. Description of the Related Art

Motorcycles and vehicles of all sizes and shapes invariably find themselves driving under conditions which cause the buildup of mud under the fenders. While the accumulation of mud under the fender may not normally be a problem for most recreational vehicles, the presence of mud under the fender of a motorcycle participating in a sporting event becomes, at best, a handicap, and at worst, a contributing cause of personal injury. When the dirt track becomes wet, the resulting mud adheres to the vehicle, adding unwanted weight, thereby lessening the chances for winning.

U.S. Patent Application Publication 2003/0121708, published in July 2003, discloses a fender assembly and associated air transfer and dirt protection system incorporating a layer of unpigmented porcelain which avoids the adherence of mud particles and dirt to the underside of the fender.

U.S. Pat. No. 5,108,129, issued to Arlen B. Olsen in April 1992, discloses an inner fender lining that can be applied against the underside of an exposed fender for protecting the fender from damage by rocks or other objects. The liner comprises a relatively thick but flexible sheet of plastic material shaped to cover the rear portion of the fender. The liner is bent to conform to the underside of the fender and fit flush thereagainst, and is held in place using the fasteners normally used to hold the fender on the vehicle.

U.S. Pat. No. 5,613,710, issued to A. Waner in March 1997, discloses a fender liner for a dual wheel fender formed of epoxy-fiberglass and having a substantially flat top and an inboard side for attachment to a vehicle with bolts along the top of the fender on the inboard side. The fender liner is formed as an elongated flat panel made of sheet material with an inboard side flange. The flat panel runs substantially the length and breadth of the flat top on the inside of the fender for guarding the underside of the flat top against damage by rocks and other objects which may be hurled up against it. The fender liner is attached to the fender along the inboard side flange by the bolts attaching the fender to the vehicle along the top of the fender.

U.S. Pat. No. 5,904,361, issued to E. Powell, in May 1999, discloses a removable mudguard system for a bicycle including one shield for the rear wheel and one shield for the front wheel. The rear wheel shield is formed into an arcuate shape that conforms to the outside surface of a top section of the rear wheel. The shield is held in place by support rods may be removed when desired.

None of the above inventions and patents, taken either singly or in combination, is seen to describe the instant invention as claimed. Thus a foam liner to prevent accumulation of mud on fenders solving the aforementioned problems is desired.

### SUMMARY OF THE INVENTION

The mud resistant motorcycle fender and liner assembly of the present invention incorporates a synthetic liner which can be applied against the underside of an exposed fender of a motorcycle or other structure susceptible to mud buildup. The present invention addresses the need of motorcycles, particularly sports vehicles engaged in racing over dirt tracks, to control the weight of their vehicles by minimizing the weight gained by dirt and mud buildup.

A liner backing, sandwiched between the protective liner and the surface to be protected functions to prevent the protective liner from delaminating.

The liner comprises a relatively thin flexible sheet of air permeable synthetic material shaped to substantially cover the concave underside portion of an exposed fender. The liner may be adhesively attached to the exposed fender, or alternatively, a liner backing may be sandwiched between the liner and the fender to stabilize the liner, thereby preventing the liner from delaminating from the surface. The liner is slightly smaller than the surface to be covered, the liner having a bead of adhesive material disposed around the edge thereof, protecting the liner from fraying and from delaminating.

Weight control due to mud buildup is accommodated by the open cell texture of the synthetic liner. The relatively high ratio of space to material content of the liner tends to minimize the ability of mud to cling to the surface.

Accordingly, it is a principal object of the invention to provide a motorcycle fender assembly that prevents mud from adhering to the tire-facing surface of the fender.

It is another object of the invention to provide a synthetic liner for a motorcycle fender that will minimize the buildup of mud on any exterior surface.

It is a further object of the invention to provide a mud resistant liner assembly for a motorcycle fender that helps to maintain a constant weight for a motorcycle racing on dirt tracks.

Still another object of the invention is to provide a method by which a mud resistant liner may be attached to a motorcycle fender.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a motorcycle fender incorporating a protective liner according to the present invention in order to prevent accumulation of mud within the concave underside surface of the motorcycle fender.

FIG. 2 is an exploded perspective view of the motorcycle fender and liner assembly according to the present invention.

FIG. 3 is a perspective, transverse section view through a motorcycle fender having the mud resistant liner assembly according to the present invention installed therein.

Similar reference characters denote corresponding features consistently throughout the attached drawings.

### DETAILED DESCRIPTION OF THE PREFERRED EMBODIMENTS

The present invention is a fender and mud protecting liner assembly, designated generally as 100 in the drawings. The fender assembly 100 has particular application in connection with motorcycles used in racing or other sporting events where the accumulation of mud or dirt would detract from the performance of the vehicle.

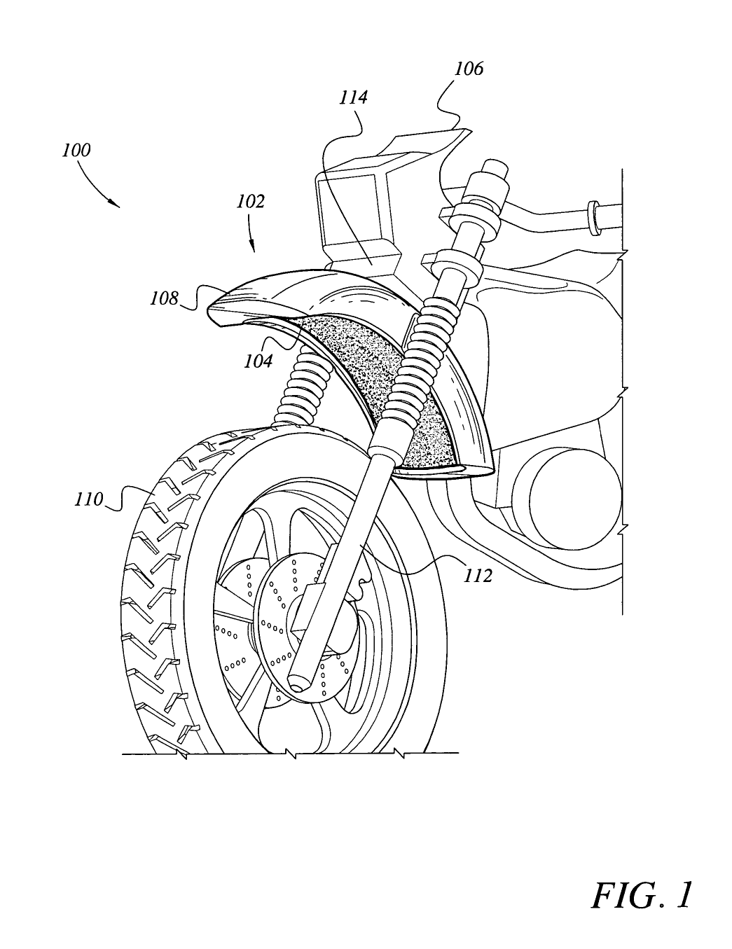

As shown in FIG. 1, the front portion of a motorcycle 106 is shown having a fender assembly 100, mounted to a motorcycle frame 114 between two parallel forked wheel mounts 112, the wheel mounts supporting the front wheel 110 of the motorcycle 106. The fender assembly 100 is mounted above the forward wheel 110 and generally forms to the curvature of the wheel 110.

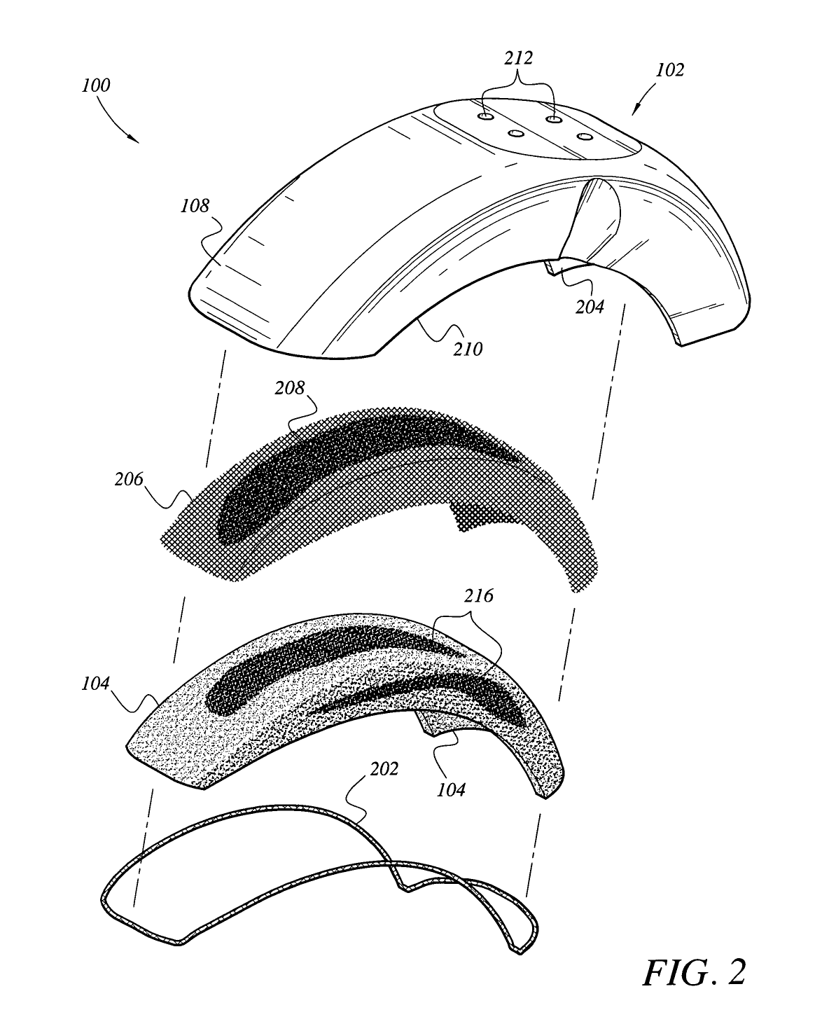

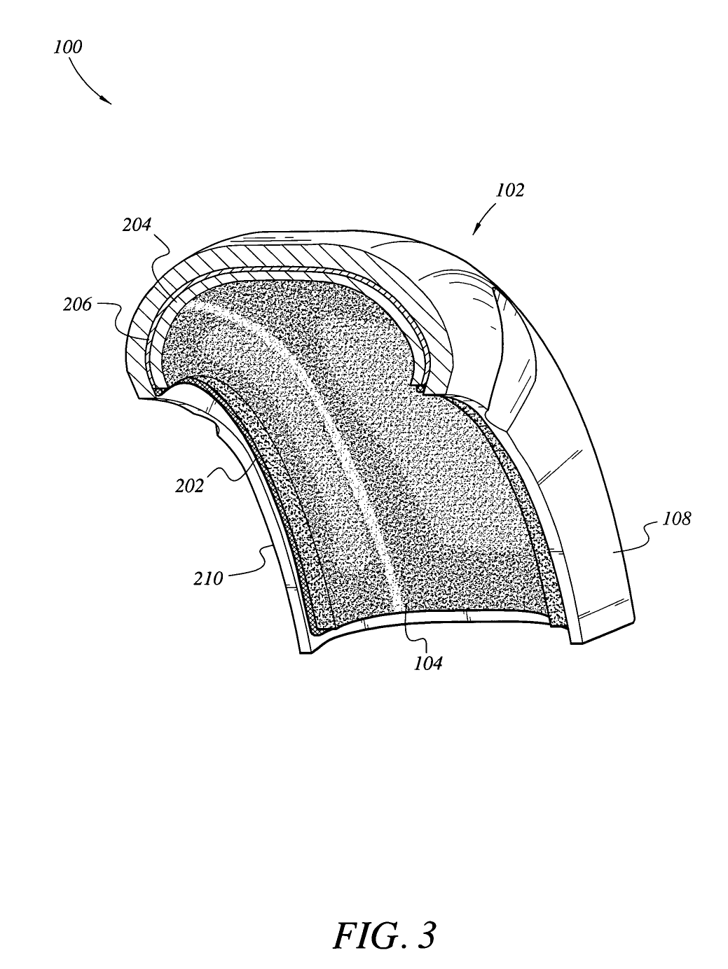

As shown in greater detail in FIGS. 2 and 3, fender assembly 100 comprises a fender 102 with an upper surface 108, a concave lower surface 204, and an outer rim 210. The fender 102 has apertures cut therethrough, allowing the fender 102 to be mounted to the frame 114 of the motorcycle 106. Although the liner 104 may be adhesively bonded directly to the lower surface 204 of the fender 102, preferably a liner backing material 206 is inserted between the liner 104 and the fender 102 to increase the bond between the lower surface 204 of the fender 102 and the liner 104, making the liner 104 resistant to delaminating due to the stresses present when the motorcycle is either engaged in competition or during normal use.

In the present invention, the backing 206 is a made of mesh material woven from monofilament fibers in a grid pattern, having a density not unlike the backing of a carpet. The upper surface of the backing 206 is adhesively attached to the lower concave surface 204 of the fender 102. An adhesive layer 208 either rolled or sprayed onto the surface 204, provides a bonding layer, which secures the backing 206 to the concave surface 204. Fender liner 104 is then glued to the lower surface of the backing 206 by means of a second adhesive layer 216.

The fender liner 104 consists of a flexible, synthetic, and air permeable material shaped to fit the lower concave surface 204. The liner 104 is approximately 1/4 inch thick and is made of a synthetic fiber or foam material. The liner 104 is preferably made from an open cell material, i.e., having interconnected cells with openings between the cells so that the material is sponge-like. The liner 104 may, for example, be made from any polymeric, plastic, open-cell foam known in the plastics art. The liner 104, as well as the backing 206, may be planar segments cut from a sheet of liner material and laid up in adjoining sections. Alternatively, the liner 104 and backing 206 may be preassembled and molded to the specific contours of the lower surface 204 of the fender 102.

The liner 104 and backing 206 extend to, but stop short of, the edge 210 of the lower concave surface 204, thereby allowing a protective bead 202 of waterproof sealant to bond the edges of the liner 104 and backing 206 to the inner concave surface 204 of the fender 102. In the present invention, the fender liner 104 and backing 206 preferably substantially cover the entire lower concave surface 204 of the fender 102, thereby providing the optimum in mud resistant protection. However, as a quick short-term remedy to the problem of mud buildup, the protective liner 104 and backing 206 may be applied to only the top portion or roof of the lower concave surface 204, thereby leaving the downwardly extending lateral sides of the fender 102 uncovered by the liner 104 and exposed to dirt or mud splashed up by the wheel. Although not as effective as the former approach, the latter will alleviate the major portion of the problem.

As mentioned previously, a further embodiment of the present invention would eliminate the backing material 206, thereby having the protective liner 104 mount directly to the lower surface 204 of the fender assembly 100. Although not as resistant to delaminating, this alternative would be slightly lighter, quicker to apply, and would offer short-term protection.

Operationally, the liner 104 retards the buildup of mud in the concave portion 204 of the fender 102, thereby maintaining a nearly constant weight of the motorcycle, or at least preventing weight being added due to the accretion of mud and debris. However, the liner 104 disclosed above is not limited to motorcycles. Any motorized or non-motorized vehicle may benefit from application of the liner 104 to the underside of a fender or wheel well and the method of use heretofore disclosed. Furthermore, any flat or round surface may be retrofitted to retard and resist any absorption or build up of agricultural, industrial, or other foreign matter by the application of the disclosed liner.

The liner 104 may be mounted in a matter of minutes and may be repaired using the same procedure. For best adhesive quality, the ambient temperature of the environment should be between 65° and 80° Fahrenheit, which can easily be achieved using a hair blow dryer. The surface to be lined must first be cleaned of all residue dirt and mud. Then the surface must be roughened, such as with 120 grit sandpaper, to provide a suitable bonding surface for the adhesive layer 216. The adhesive should be a professional grade adhesive and can be either sprayed on or rolled on. For use in the fender assembly 100, the adhesive used was 3M® HIGH STRENGTH 90 SPRAY ADHESIVE.

As previously stated, the liner 104 and backing 206 may be preformed or cut from a sheet of liner material. Once the adhesive is applied, a roller may be used to apply a uniform pressure to the liner, thereby helping to squeegee out air pockets and create a uniform and secure bond. Finally, a bead of adhesive sealant material is applied around the edges of the liner and backing to protect the edge from fraying and from delaminating.

It is to be understood that the present invention is not limited to the embodiments described above, but encompasses any and all embodiments within the scope of the following claims.

1. A mud resistant assembly for a motorcycle fender, comprising:
an air permeable liner dimensioned an configured for attachment to a lower surface of the motorcycle fender.

2. The mud resistant assembly according to claim 1, wherein said liner is made of a synthetic material approximately one fourth of an inch thick.

3. The mud resistant assembly according to claim 1, wherein said liner is made of a flexible compressible material.

4. The mud resistant assembly according to claim 1, wherein said liner is made of an open-cell material.

5. The mud resistant assembly according to claim 1, wherein said liner is made from an open-cell, polymeric, plastic material.

6. The mud resistant assembly according to claim 1, further comprising a layer of adhesive bonding said liner to the motorcycle fender.

7. The mud resistant assembly according to claim 1, further comprising:
a backing material adapted for attachment to the lower surface of the motorcycle fender; and
a first layer of adhesive bonding said liner to said backing.

8. The mud resistant assembly according to claim 7, further comprising a second layer of adhesive bonding said backing to the motorcycle fender.

9. The mud resistant assembly according to claim 7, wherein said backing material is comprised of a woven mesh of monofilament fibers.

10. The mud resistant assembly according to claim 1, further comprising a bead of sealant disposed around the edge of said liner for sealing the liner to the fender.

11. The mud resistant assembly according to claim 1, wherein the liner extends to within approximately 1/4 inch of a lower edge of the fender.

12. A mud resistant motorcycle fender assembly, comprising:
a fender having and upper surface and a concave lower surface, the fender being adapted for attachment to a motorcycle;
a mesh backing adhesively attached to the lower surface of the fender; and
an open-cell foam liner adhesively attached to the mesh backing.

13. A method of forming a mud resistant protective liner on a surface of a vehicle above a vehicle wheel for preventing an accumulation of mud, comprising the steps of:
preparing the surface for application of an adhesive;
applying a first layer of high strength adhesive to the surface;
firmly applying a backing material to said first layer of adhesive;
applying a second layer of high strength adhesive to said backing material; and
firmly applying a layer of synthetic, air permeable material to said second adhesive layer in order to form a protective liner.

14. The method of forming a mud resistant protective liner according to claim 13, wherein said step of preparing the surface further comprises the steps of:
removing loose material from said surface; and
abrading the surface.

15. The method of forming a mud resistant protective liner according to claim 13, further comprising the step of applying heat in order to raise the surface to a sufficient temperature to achieve a strong bond between the protective liner, the backing material, and the surface.

16. The method of forming a mud resistant protective liner according to claim 13, further comprising the step of applying a roller to the air permeable material in order to squeeze air bubbles from the adhesive in order to achieve a uniform and secure bond between said protective liner, the surface; and the backing material sandwiched therebetween.

17. The method of forming a mud resistant protective liner according to claim 13, further comprising the step of applying a bead of waterproof sealant around said protective liner and said backing material in order to form a seal between the protective liner and the surface.
